(19) United States
(12) Patent Application Publication
(10) Pub. No.: US 2020/0319509 A1
(43) Pub. Date: Oct. 8, 2020

(54) SEMI-REFLECTIVE AND SEMI-TRANSMISSIVE DISPLAY PANEL AND DISPLAY DEVICE WITH THE DISPLAY PANEL

(71) Applicant: WUHAN CHINA STAR OPTOELECTRONICS TECHNOLOGY CO., LTD., Wuhan, Hubei (CN)

(72) Inventor: Fancheng LIU, Wuhan, Hubei (CN)

(21) Appl. No.: 16/300,590

(22) PCT Filed: Sep. 11, 2018
(86) PCT No.: PCT/CN2018/104933

§ 371 Date: Nov. 12, 2018

(30) Foreign Application Priority Data
Jul. 27, 2018 (CN) 201810843443.5

(51) Int. Cl. G02F 1/13357

(52) U.S. Cl. CPC G02F 1/133605; G02F 2203/02; G02F 2203/01

(57) ABSTRACT

A semi-reflective and semi-transmissive display panel is provided and includes a first substrate and a second substrate. A liquid crystal layer is disposed between the first substrate and the second substrate. The semi-reflective and semi-transmissive display panel includes a displaying region, and the displaying region includes a transmissive displaying region and a reflective displaying region. In the reflective displaying region, a micro structured reflective layer is disposed in a surface of the first substrate facing away from the second substrate.

### FIELD OF INVENTION

The present invention relates to display device fields, especially relates to a semi-reflective and semi-transmissive display panel and a display device with the display panel.

### BACKGROUND OF INVENTION

Display devices include transmissive display devices, employing transmissive light from a backlight on a rear of a screen, for display, and reflective display devices, employing external reflected light, for display. The transmissive display devices have advantages of high saturation and excellent viewability in a dark environment. One disadvantage of the transmissive display devices is high power consumption no matter whether the environment is bright or dark. The reflective display devices have advantages of low power consumption and excellent viewability in a bright environment. One disadvantage of the reflective display devices is low viewability in the dark environment.

In view of the disadvantages of the above transmissive display devices and reflective display devices, a semi-reflective and semi-transmissive display device is developed accordingly. The semi-reflective and semi-transmissive display device includes features of both the transmissive display device and the reflective display device. The semi-reflective and semi-transmissive liquid crystal display device employs transmissive light of a backlight in the dark environment for display, and employs an external reflected light in the bright environment for display. The semi-reflective and semi-transmissive liquid crystal display device is highly viewable under the bright and dark environments and has low power consumption, and therefore is used as a display mainly for electrical appliances, such as portable electrical appliances used outdoors.

### Technical Issue

FIG. 1 is a structural schematic view of a conventional semi-reflective and semi-transmissive display device. With reference to FIG. 1, the semi-reflective and semi-transmissive display device includes a liquid crystal panel 10 and a backlight source 11. The liquid crystal panel 10 includes an array substrate 100 and a color filter substrate 101 opposite to the array substrate 100. A displaying region between the array substrate 100 and the color filter substrate 101 is filled with a liquid crystal layer 102. FIG. 1 only illustratively depicts a schematic view of the displaying region. The displaying region includes a transmissive displaying region A and a reflective displaying region B. In the transmissive displaying region A, a light of the backlight source 11 can be directly emitted out through the liquid crystal panel 10 such that a transmissive light L1 of the backlight source 11 is used in the transmissive displaying region A for display. In the reflective displaying region B, a reflection layer 103 is disposed on the array substrate 100. An external light L2, after entering the liquid crystal panel 10, is reflected by the reflection layer 103 and then is emitted out such that a reflected light from the external light is used in the reflective displaying region B for display.

However, the semi-reflective and semi-transmissive display device has some shortages as follows. To enhance transmissive displaying performance and to ensure a large area of the transmissive displaying region, an area of the reflective displaying region is inevitably decreased such that the reflective displaying performance is lowered. On the contrary, to ensure the reflective displaying performance equal to that of a reflective display device, the large area of the reflective displaying region must be ensured such that the transmissive displaying performance is lowered. Therefore, a trade-off relationship exists between the area of the transmissive displaying region and the reflective displaying performance. Moreover, with reference to FIG. 1, in the semi-reflective and semi-transmissive display device, in the reflective displaying region B, because the reflection layer 103 is not light-transmissive, a light L3 emitted by the backlight source 11 is reflected by the reflection layer 103 back to the backlight source 11. The reflected light cannot be employed effectively such that a usage rate of the backlight source in the reflective displaying region B.

In view of the above disadvantages of the above semi-reflective and semi-transmissive display device, developing a new semi-reflective and semi-transmissive display panel and a display device with the display panel is significantly important.

### SUMMARY OF INVENTION

The present invention, to solve the above technical issue, provides a semi-reflective and semi-transmissive display panel and a display device with the display panel that can ensure unchanged reflection performance of a reflective displaying region while enhancing a brightness of transmissive displaying and lower power consumption of the backlight module such that the semi-reflective and semi-transmissive display device has better displaying endurance outdoors.

To solve the above issue, the present invention provides a semi-reflective and semi-transmissive display panel comprising a first substrate and a second substrate, the first substrate and the second substrate disposed opposite to each other, a liquid crystal layer disposed between the first substrate and the second substrate, the semi-reflective and semi-transmissive display panel comprising a displaying region, the displaying region comprising a transmissive displaying region and a reflective displaying region; a micro structured reflective layer disposed on a surface of the first substrate facing away from the second substrate in the reflective displaying region, the micro structured reflective layer configured to reflect an incident light from a backlight module, the micro structured reflective layer composed of a plurality of protrusions having a tilt angle, a width of each of the protrusions greater than a wavelength of a visible light, and an outer light reflecting layer disposed on a surface of the first substrate facing toward the second substrate in the reflective displaying region.

To solve the above issue, the present invention also provides a semi-reflective and semi-transmissive display panel comprising a first substrate and a second substrate, the first substrate and the second substrate disposed opposite to each other, a liquid crystal layer disposed between the first substrate and the second substrate, the semi-reflective and semi-transmissive display panel comprising a displaying region, the displaying region comprising a transmissive displaying region and a reflective displaying region; a micro structured reflective layer disposed on a surface of the first substrate facing away from the second substrate in the reflective displaying region, wherein the micro structured reflective layer is configured to reflect an incident light from a backlight module.

In an embodiment, the micro structured reflective layer is composed of a plurality of protrusions having a tilt angle.

In an embodiment, the tilt angle fulfills a conditional formula as follows:

tan(180−2α)½L′/h

wherein, α is a tilt angle of the protrusions, h is a height of a gap between the backlight module and the first substrate, L′ is a length of the reflective displaying region.

In an embodiment, the tilt angle is greater than 75 degrees.

In an embodiment, the tilt angle is equal to 75 degrees.

In an embodiment, a width of each of the protrusions is greater than a wavelength of a visible light.

In an embodiment, wherein heights of the protrusions are at different.

In an embodiment, in the reflective displaying region, an outer light reflecting layer is disposed on a surface of the first substrate facing toward the second substrate.

In an embodiment, in the transmissive displaying region, a metal wire grid is disposed on a surface of the first substrate facing toward the second substrate.

In an embodiment, a height of metal wires of the metal wire grid is 100 nm-150 nm, an interval between adjacent metal wires of the metal wire grid is 100 nm-150 nm, and a duty ratio of the metal wire grid is 40%-60%.

In an embodiment, in the transmissive displaying region, a metal wire grid is disposed on the surface of the first substrate facing away from the second substrate.

In an embodiment, a height of metal wires of the metal wire grid is 100 nm-150 nm, an interval between adjacent metal wires of the metal wire grid is 100 nm-150 nm, and a duty ratio of the metal wire grid is 40%-60%.

To solve the above technical issues the present invention also provides a semi-reflective and semi-transmissive display device comprising the above semi-reflective and semi-transmissive display panel and a backlight module, the backlight module disposed on a rear surface of the semi-reflective and semi-transmissive display panel, wherein in the reflective displaying region, an incident light of the backlight module is multi-reflected by the micro structured reflective layer and the backlight module and is emitted out from the transmissive displaying region.

### Advantageous Effect

Advantages of the present invention are as follows. By disposing the micro structured reflective layer on the reflective displaying region B and directionally reflecting a light of the reflective displaying region, the light of the reflective displaying region is reflected by the micro structured reflective layer to the transmissive displaying region to increase usage rate of the light of the backlight module of the reflective displaying region and brightness of the light from the transmissive displaying region such that transmissive displaying brightness is enhanced and lower consumption of the backlight module is lowered while reflection performance of the reflective displaying region is ensured to be unchanged.

### DESCRIPTION OF DRAWINGS

FIG. 1 is a structural schematic view of a conventional semi-reflective and semi-transmissive display device;

FIG. 2 is a structural schematic view of an embodiment of a semi-reflective and semi-transmissive display panel of the present invention;

FIG. 3 is a schematic view of a light path of the semi-reflective and semi-transmissive display panel of present invention;

FIG. 4 is a schematic view of a light path of protrusions of the present invention;

FIG. 5 is a structural schematic view of another embodiment of the semi-reflective and semi-transmissive display panel of the present invention; and

FIG. 6 is a structural schematic view of the semi-reflective and semi-transmissive display device of the present invention.

### DETAILED DESCRIPTION OF PREFERRED EMBODIMENTS

### Best Mode of Embodiments of the Present Invention

Specific embodiments of the semi-reflective and semi-transmissive display panel and the display device with the display panel provided by the present invention will be described in details accompanied with drawings as follows.

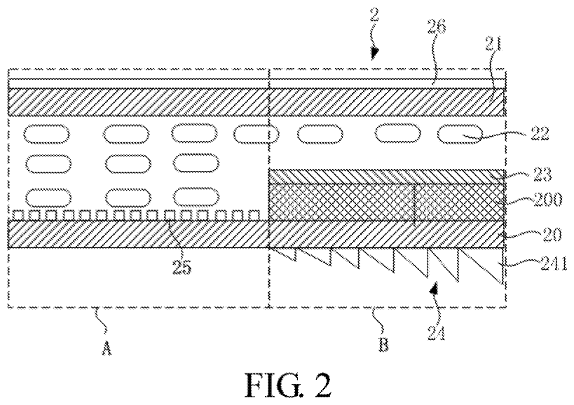

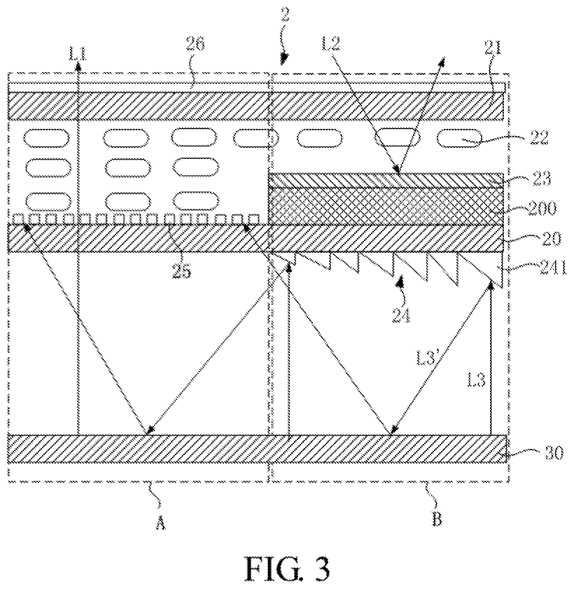

The present invention provides a semi-reflective and semi-transmissive display panel. FIG. 2 is a structural schematic view of an embodiment of a semi-reflective and semi-transmissive display panel of the present invention. FIG. 3 is a schematic view of a light path of the semi-reflective and semi-transmissive display panel of present invention. With reference to FIG. 2, the present invention semi-reflective and semi-transmissive display panel 2 includes a first substrate 20 and a second substrate 21. The first substrate 20 and the second substrate 21 are disposed opposite to each other. A liquid crystal layer 22 is disposed between the first substrate 20 and the second substrate 21. In the present embodiment, the first substrate 20 is an array substrate, and has a thin film transistor (TFT) device layer 200 disposed on the first substrate 20. The second substrate 21 is a color filter substrate.

The semi-reflective and semi-transmissive display panel 2 includes a displaying region and a non-displaying region, the displaying region configured to display images, and the non-displaying region configured to manufacture structure such as wires and frames. The non-displaying region of the present invention semi-reflective and semi-transmissive display panel 2 is a common structure and will not be repeatedly described. FIG. 2 is a schematic view only schematically illustrating the displaying region.

The displaying region of the semi-reflective and semi-transmissive display panel 2 includes a transmissive displaying region A and a reflective displaying region B. Each pixel of the semi-reflective and semi-transmissive display panel 2 includes a transmissive displaying region and a reflective displaying region. The transmissive displaying regions of all pixels form the transmissive displaying region of the semi-reflective and semi-transmissive display panel. The reflective displaying regions of all pixels form the reflective displaying region of the semi-reflective and semi-transmissive display panel 2. In the present embodiment, the transmissive displaying region and the reflective displaying region of one pixel are taken as an example to describe the technical solution of the present invention.

With reference to FIGS. 2 and 3, in the transmissive displaying region A, light L1 from the backlight module 30 can be emitted out directly through the semi-reflective and semi-transmissive display panel 2 such that the transmissive displaying region A employs the transmissive light of the backlight module 30 to display images. In the reflective displaying region B, An outer light reflecting layer 23 is disposed on a surface of the first substrate 20 facing toward the second substrate 21. An external light L2, after entering the semi-reflective and semi-transmissive display panel 2, is reflected by the outer light reflecting layer 23 and then is emitted out such that the reflective displaying region B employs the reflected light to display images. The outer light reflecting layer 23 can be disposed on a surface of the thin film transistor (TFT) device layer 200.

With reference to FIGS. 2 and 3, in the reflective displaying region B, a micro structured reflective layer 24 is disposed in a surface of the first substrate 20 facing away from the second substrate 21. The micro structured reflective layer 24 can reflect an incident light of the backlight module 30. Because the micro structured reflective layer 24 is disposed on a rear surface of the first substrate 20, i.e., the surface of the semi-reflective and semi-transmissive display panel 2 facing toward the backlight module 30, in the reflective displaying region B, a backlight L3 emitted from the backlight module 30 can be emitted out from the micro structured reflective layer 24. To clear describe the technical solution of the present invention, micro structured reflective layer 24 shown in the figure is enlarged adequately.

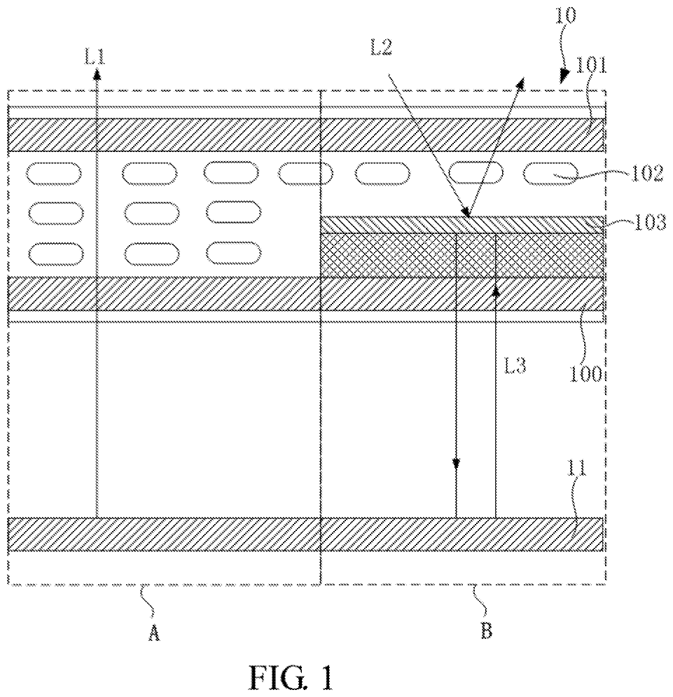

FIG. 3 is a schematic view of a light path of the present invention semi-reflective and semi-transmissive display panel. With reference to FIG. 3, in comparison to a conventional semi-reflective and semi-transmissive display panel 10 (shown in FIG. 1) without the micro structured reflective layer 24, the present invention semi-reflective and semi-transmissive display panel 2 employing the micro structured reflective layer 24 can change a reflection direction of the backlight L3 emitted from the backlight module 30 at the display panel 2. In detail, the backlight L3, after reflected by the micro structured reflective layer 24, forms a reflected light L3′. The reflected light L3′ is not emitted incidentally into the surface of the backlight module 30 at an angle of incidence near 90 degrees, but is emitted incidentally into the surface of the backlight module 30 at an angle of incidence less than 90 degrees. The backlight L3 (i.e., the reflected light L3′ of the backlight L3) will again be reflected by the backlight module 30 and is probably emitted incidentally into the transmissive displaying region A to serve as a light source of the transmissive displaying region A. If the backlight L3 is reflected by the backlight module 30 once again, instead of being emitted incidentally into the transmissive displaying region A, but is emitted incidentally into the micro structured reflective layer 24 again, the backlight L3 will be eventually emitted incidentally into the transmissive displaying region A after one or more further reflections of the micro structured reflective layer 24 and backlight module 30. In other words, in the reflective displaying region B, incident light of the backlight module 30, after multi-reflection of the micro structured reflective layer 24 and the backlight module 30, can be emitted out from the transmissive displaying region A.

Furthermore, as shown in FIGS. 2 and 3, the micro structured reflective layer 24 is composed of a plurality of protrusions 241. A Width of the protrusion 241 is greater than a wavelength of a visible light. For example, the width of the protrusion 241 is greater than 2 microns. The protrusions 241 are in different heights, as shown in FIG. 2 to prevent the protrusions 241 are occluded from one another and to enhance usage rate of the reflected light.

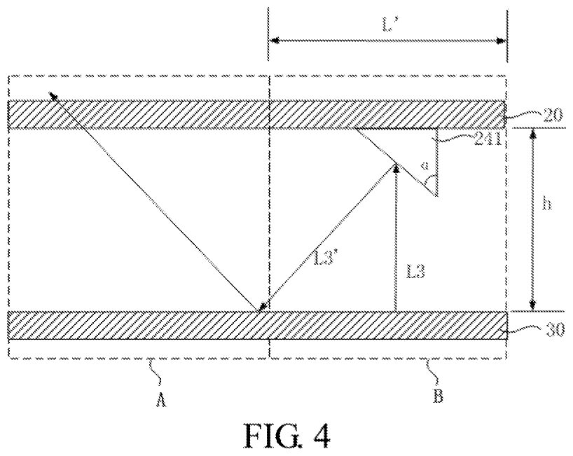

FIG. 4 is a schematic view of a light path of the protrusions 241. With reference to FIG. 4, the protrusions 241 all have tilt angles α. The tilt angle α is an included angle of a reflective surface and a vertical surface of the protrusions 241. Because the tilt angle of the protrusion 241 is a, an angle of incidence of a reflected light L3′ formed from the backlight L3 reflected by the micro structured reflective layer 24, on the backlight module 30, is 180-2α.

In the present embodiment, the tilt angle α the protrusions 241 should fulfill the a conditional formula as follows:

tan(180−2α)≥½L′/h

wherein α is the tilt angle of the protrusion 241; h refers to a height of a gap between the backlight module 30 and the first substrate 20, and L′ is a length of the reflective displaying region B. In actual design of the semi-reflective and semi-transmissive display panel, a width and a length of the pixel is known. According to the width and length of the pixel and a desired reflective rate, the length L′ reflective displaying region B can be acquired.

When the tilt angle α fulfills the conditional formula, it is guaranteed that the reflected light of the protrusions 241 on an edge of the reflective displaying region B can also enter transmissive displaying region A. Furthermore, the tilt angle α is greater than or is equal to 75 degrees, then an angle of emergence of the transmissive light after multi-reflection of the micro structured reflective layer 24 and the backlight module 30 and emitting out from the transmissive displaying region A is greater than 70 degrees. The transmissive light can be used efficiently. Furthermore, the above conditional formula is especially suitable for the direct-lit backlight module 30, dual-edge-lit and single-edge-lit backlight modules need no consideration for the above conditional formula.

Furthermore, in the transmissive displaying region A, a metal wire grid 25 is disposed on the surface of the first substrate 20 facing toward the second substrate 21 or the surface of the first substrate 20 facing away from the second substrate 21.

With reference to FIGS. 2 and 3, the metal wire grid 25 is disposed on the surface of the first substrate 20 facing toward the second substrate 21.

### Embodiments of the Present Invention

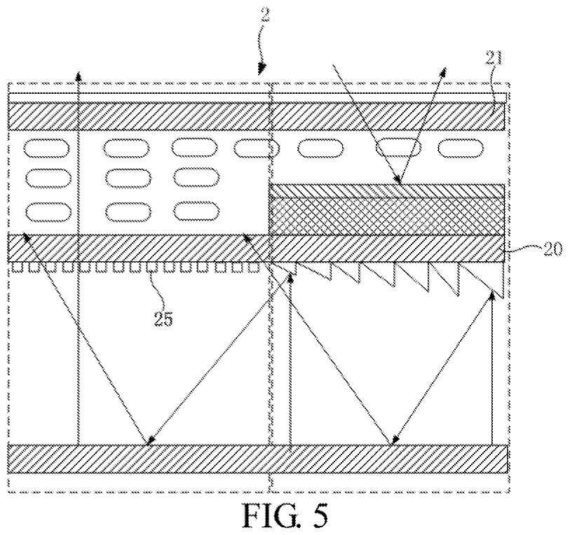

With reference to FIG. 5, in another embodiment of the semi-reflective and semi-transmissive display panel 2 of the present invention, the metal wire grid 25 is disposed on the surface of the first substrate 20 facing away from the second substrate 21. The metal wire grid 25 serves as a polarizer of the present invention semi-reflective and semi-transmissive display panel 2.

As shown in FIGS. 2 and 3, the reflective displaying region B is not disposed with the metal wire grid 25 and the polarizer, such that fitting performance of the polarizer is prevented from getting poorer due to the additional micro structured reflective layer 24. Preferably, a height of metal wires of the metal wire grid 25 is 100 nm-150 nm, an interval between adjacent metal wires of the metal wire grid 25 is 100 nm-150 nm, and a duty ratio of the metal wire grid 25 is 40%-60%, the above configuration can further enhance usage rate of the light after multi-reflection of the micro structured reflective layer 24 and the backlight module 30 and then emitted out from the transmissive displaying region A.

Furthermore, as shown in FIGS. 2 and 3, a polarizer 26 is disposed on the surface of the second substrate 21 facing away from the first substrate 20. The polarizer 26 cooperates with the metal wire grid 25 to achieve display of the semi-reflective and semi-transmissive display panel.

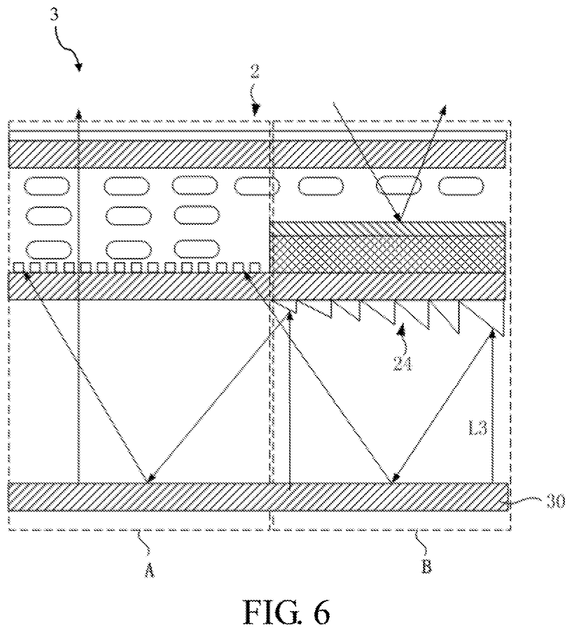

The present invention also provides a semi-reflective and semi-transmissive display device, which can be a computer, a television or a smart electrical product. FIG. 6 is a schematic view of an internal structure of the semi-reflective and semi-transmissive display device 3 of the present invention. With reference to FIG. 6, the semi-reflective and semi-transmissive display device 3 includes any one of the embodiments of the semi-reflective and semi-transmissive display panel 2 and the backlight module 30 as shown in FIG. 2 or 5. The backlight module 30 is disposed on a rear surface of the semi-reflective and semi-transmissive display panel 2. In the reflective displaying region B, the incident light L3 of the backlight module 30 is double-reflected by the micro structured reflective layer 24 and the backlight module 30 and then is emitted out from the transmissive displaying region A.

The semi-reflective and semi-transmissive display panel 2 and display device adopting the display panel 2 of the present invention, by disposing the micro structured reflective layer 24 on the reflective displaying region B to directionally reflect the light of the reflective displaying region B, reflects the light of the reflective displaying region B through the micro structured reflective layer 24 to be emitted out from the transmissive displaying region A, increases usage rate of the backlight module of the reflective displaying region B, enhances brightness of the emitted light of the transmissive displaying region A, increases the brightness of transmissive display with reflection performance of the reflective displaying region B remaining the same, and lowers power consumption of the backlight module to allow the semi-reflective and semi-transmissive display device to have better displaying endurance outdoors.

What is claimed is:

1. A semi-reflective and semi-transmissive display panel, comprising a first substrate and a second substrate, the first substrate and the second substrate disposed opposite to each other, a liquid crystal layer disposed between the first substrate and the second substrate, the semi-reflective and semi-transmissive display panel comprising a displaying region, the displaying region comprising a transmissive displaying region and a reflective displaying region; a micro structured reflective layer disposed on a surface of the first substrate facing away from the second substrate in the reflective displaying region, the micro structured reflective layer configured to reflect an incident light from a backlight module, the micro structured reflective layer composed of a plurality of protrusions having a tilt angle, a width of each of the protrusions greater than a wavelength of visible light, and an outer light reflecting layer disposed on a surface of the first substrate facing toward the second substrate in the reflective displaying region.

2. A semi-reflective and semi-transmissive display panel, comprising a first substrate and a second substrate, the first substrate and the second substrate disposed opposite to each other, a liquid crystal layer disposed between the first substrate and the second substrate, the semi-reflective and semi-transmissive display panel comprising a displaying region, the displaying region comprising a transmissive displaying region and a reflective displaying region; a micro structured reflective layer disposed on a surface of the first substrate facing away from the second substrate in the reflective displaying region, wherein the micro structured reflective layer is configured to reflect an incident light from a backlight module.

3. The semi-reflective and semi-transmissive display panel as claimed in claim 2, wherein the micro structured reflective layer is composed of a plurality of protrusions having a tilt angle.

4. The semi-reflective and semi-transmissive display panel as claimed in claim 3, wherein the tilt angle fulfills a conditional formula as follows:
tan(180−2α)≥½L′/h
wherein, α is a tilt angle of the protrusions, h is a height of a gap between the backlight module and the first substrate, L′ is a length of the reflective displaying region.

5. The semi-reflective and semi-transmissive display panel as claimed in claim 4, wherein the tilt angle is greater than 75 degrees.

6. The semi-reflective and semi-transmissive display panel as claimed in claim 4, wherein the tilt angle is equal to 75 degrees.

7. The semi-reflective and semi-transmissive display panel as claimed in claim 3, wherein α width of each of the protrusions is greater than a wavelength of visible light.

8. The semi-reflective and semi-transmissive display panel as claimed in claim 3, wherein heights of the protrusions are different.

9. The semi-reflective and semi-transmissive display panel as claimed in claim 2, wherein in the reflective displaying region, an outer light reflecting layer is disposed on a surface of the first substrate facing toward the second substrate.

10. The semi-reflective and semi-transmissive display panel as claimed in claim 2, wherein in the transmissive displaying region, a metal wire grid is disposed on a surface of the first substrate facing toward the second substrate.

11. The semi-reflective and semi-transmissive display panel as claimed in claim 10, wherein α height of metal wires of the metal wire grid is 100 nm-150 nm, an interval between adjacent metal wires of the metal wire grid is 100 nm-150 nm, and a duty ratio of the metal wire grid is 40%-60%.

12. The semi-reflective and semi-transmissive display panel as claimed in claim 2, wherein in the transmissive displaying region, a metal wire grid is disposed on the surface of the first substrate facing away from the second substrate.

13. The semi-reflective and semi-transmissive display panel as claimed in claim 12, wherein α height of metal wires of the metal wire grid is 100 nm-150 nm, an interval between adjacent metal wires of the metal wire grid is 100 nm-150 nm, and a duty ratio of the metal wire grid is 40%-60%.

14. A semi-reflective and semi-transmissive display device, comprising the semi-reflective and semi-transmissive display panel as claimed in claim 2 and a backlight module, the backlight module disposed on a rear surface of the semi-reflective and semi-transmissive display panel, wherein in the reflective displaying region, an incident light of the backlight module is multi-reflected by the micro structured reflective layer and the backlight module and is emitted out from the transmissive displaying region.
